(19) United States
(12) Patent Application Publication
(10) Pub. No.: US 2012/0262748 A1
(43) Pub. Date: Oct. 18, 2012

(54) SYSTEM AND METHOD OF PROCESSING DOCUMENTS PROTECTED UNDER A DIGITAL RIGHTS MANAGEMENT SCHEME

(75) Inventor: Sherry Siu-Ling Tan, Rancho Palos Verdes, CA (US)

(73) Assignee: XEROX CORPORATION, Norwalk, CT (US)

(21) Appl. No.: 13/086,155

(22) Filed: Apr. 13, 2011

(51) Int. Cl. G06K 15/02

(52) U.S. Cl. 358/1.14

(57) ABSTRACT

A method of printing a document may include receiving a print stream including a document to be printed and a license associated with the document that may include one or more digital rights management (DRM) privileges. The method may include identifying output management operations associated with printing the document, and, for each output management operation determining whether the output management operation violates any of the DRM privileges, in response to the output management operation violating a DRM privilege, assigning a first status to the output management operation, and in response to the output management operation not violating one or more of the DRM privileges, assigning a second status to the output management operation. The method may include assigning the document to a print device that is DRM-compliant and capable of printing the document in accordance with each print attribute, and instructing the print device to print the document.

### BACKGROUND

Current output management systems rely on external, manual processes to make determinations about how a secured document, such as one protected under a Digital Rights Management scheme, should be printed. These processes are inefficient and labor intensive, and delay the turnaround time for printing secured documents.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimensions recited below. Nothing in this document is to be construed as an admission that the embodiments described in this document are not entitled to antedate such disclosure by virtue of prior invention. As used herein, the term “comprising” means “including, but not limited to.”

In an embodiment, a method of printing a document having digital rights management privileges may include receiving, by an output management system, a print stream including a document to be printed and a license associated with the document. The license may include one or more digital rights management (DRM) privileges. The method may include identifying, by the output management system, one or more output management operations associated with printing the document, and, for each output management operation determining, by the output management system, whether the output management operation violates any of the DRM privileges associated with the document, in response to the output management operation violating one or more of the DRM privileges, assigning, by the output management system, a first status to the output management operation, and in response to the output management operation not violating one or more of the DRM privileges, assigning, by the output management system, a second status to the output management operation. The method may include assigning, by the output management system, the document to a print device that is DRM-compliant and capable of printing the document in accordance with each print attribute associated with the document, and instructing the print device, by the output management system, to print the document in accordance with each output management operation having the second status.

In an embodiment, a system of printing a document having digital rights management privileges may include a computing device and a computer-readable storage medium in communication with the computing device. The computer-readable storage medium may include one or more programming instructions that, when executed, cause the computing device to receive a print stream having a document to be printed and a license associated with the document, where the license includes one or more digital rights management (DRM) privileges. The computer-readable storage medium may include one or more programming instructions that, when executed, cause the computing device to identify one or more output management operations associated with printing the document, and for each output management operation, determine whether the output management operation violates any of the DRM privileges associated with the document, in response to the output management operation violating one or more of the DRM privileges, assign a first status to the output management operation, and in response to the output management operation not violating one or more of the DRM privileges, assign a second status to the output management operation. The computer-readable storage medium may include one or more programming instructions that, when executed, cause the computing device to assign the document to a print device that is DRM-compliant and capable of printing the document in accordance with each print attribute associated with the document, and instruct the print device to print the document in accordance with each output management operation having the second status.

In an embodiment, a system of printing a document having digital rights management privileges may include a workflow system and an output management system in communication with the workflow system. The output management system may be configured to receive a print stream from the workflow system via a print queue. The print stream may include a document and a license associated with the document. The license may include one or more digital rights management (DRM) privileges. The system may include one or more print devices in communication with the output management system. The output management system may be configured to route the print stream to one of the one or more print devices based on one or more of the DRM privileges and one or more print attributes associated with the document.

### BRIEF DESCRIPTION OF THE DRAWINGS

FIG. 1 illustrates an exemplary document production environment according to an embodiment.

FIG. 2 illustrates an exemplary method of printing a DRM document according to an embodiment.

FIG. 3 illustrates exemplary internal hardware that may be used to contain or implement program instructions according to an embodiment.

### DETAILED DESCRIPTION

The following terms shall have, for purposes of this application, the respective meanings set forth below:

A “document” refers to a logical unit of work that is processed in a document production environment. A document may include text, images and/or the like, and may be embodied in an electronic format or a physical substrate.

“Print attributes” are characteristics of a printed document, such as ink type, gloss, paper size, paper weight and/or the like.

A “Digital Rights Management (DRM) document” refers to an encrypted document having an associated DRM license.

A “printing device” refers to an electronic apparatus that is capable of receiving commands, printing text, vector graphics and/or images on a substrate, and optionally, also scanning or otherwise processing a document. Printing devices may include, but are not limited to, network printers, production printers, copiers, facsimile machines and/or other devices using ink or toner.

An “output management system” is a computer system that schedules and/or directs documents to printing devices. An output management system may include one or more computing or other devices needed to output a document. An output management system in a print environment may include one or more computing devices and/or printing devices needed to output a document.

“Digital Rights Management privileges” or “DRM privileges” are access control rights that impose limitations on how digital content can be used, accessed, modified, printed and/or the like. DRM privileges may include limitations as to who can access the document, how many copies of the document can be printed, who is able to modify the document and/or the like.

A “Digital Rights Management license” or “DRM license” is a file that describes the DRM privileges associated with a DRM document. A DRM license may be a separate file or it may be part of a document. For example, a DRM license may describe DRM privileges to a DRM document's content, identify the users or devices to whom the rights are granted and/or identify the conditions under which the rights are granted.

A “workflow system” is a computer system that implements and/or performs an ordered sequence of operations designed to enable repeatable processing of documents.

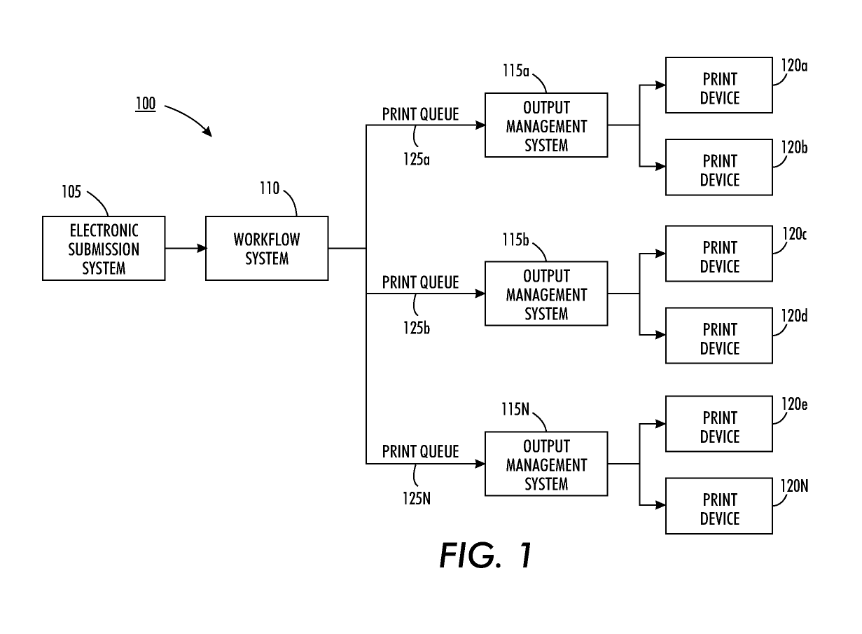

FIG. 1 is a block diagram that shows an example of a document production environment 100. A document may enter the document production environment manually or electronically and be collected at an electronic submission system 105, such as a computing device and/or scanner. Documents may be sorted and batched at the submission system or another location. In an embodiment, a document may be received by a workflow system 110. As illustrated by FIG. 1, a document may be received by an output management system 115a-N. The output management system 115a-N may manage a plurality of print devices 120a-N. The output management system 115a-N may schedule a particular document to a particular print device based on the print device's availability, the document's print attributes and/or the like.

In an embodiment, an output management system 115a-N may receive a document from a workflow system 110. In an embodiment, as illustrated by FIG. 1, an output management system 115a-N may be associated with one or more print queues 125a-N. For example, a workflow system operator may select a print queue 125a-N to use to print a document. The selected print queue 125a-N may be associated with an output management system 115a-N. As such, a workflow system operator may select a queue to direct a document, but not a specific print device 120a-N.

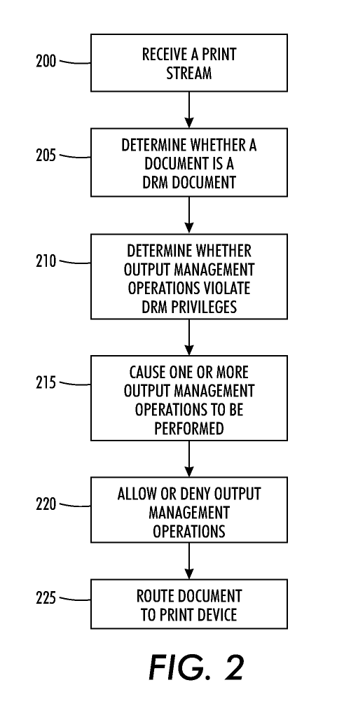

FIG. 2 illustrates an exemplary method of printing a DRM document according to an embodiment. As illustrated by FIG. 2, an output management system may receive 200 a print stream that includes an embedded document to be printed. In an embodiment, an output management system may receive 200 a print stream from a workflow system. In an alternate embodiment, an output management system may receive 200 a print stream from another computing device.

In an embodiment, a document to be printed may be protected by one or more associated DRM privileges. Such a document may be referred to as a DRM document. A DRM document may have an associated DRM license. A DRM license may describe the DRM privileges associated with a DRM document. For example, a DRM license may describe the rights and/or privileges to the DRM document's content, identify the users or devices to whom the rights are granted and/or identify the conditions under which the rights are granted. Exemplary DRM privileges may include a time before which and/or after which a DRM document cannot be printed, a number of copies of a DRM document that can be printed at one time, a total number of copies of a DRM document that can be printed, a user or users who can print a DRM document, a user or users who can view a DRM document and/or the like.

In an embodiment, the output management system may determine 205 whether a document to be printed is a DRM document. For example, the output management system may determine 205 whether a document is a DRM document by checking whether the print stream in which the document is embedded includes an associated license.

In response to a document being identified as a DRM document, the output management system may determine 210 whether one or more output management operations violate one or more of the DRM privileges set forth in the document's license. An output management operation is an operation associated with printing a document. For example, output management operations may include previewing a document, printing a document, forwarding a document, and/or the like.

In an embodiment, an output management system may determine 210 whether one or more output management operations violate one or more of the DRM privileges set forth in the document's license by comparing each output management operation to each DRM privilege in the document's license to determine whether an output management operation violates any of the DRM privileges. In an embodiment, an output management system may use a local or remote source of information, including, but not limited to a database and/or a lookup table, to compare an output management operation to a DRM privilege.

For example, an output management system may query a remote clearinghouse to obtain a number of copies of a document that have been printed to date. The output management system may compare this number with an allowed maximum number of copies that can be printed as permitted by the document's DRM license. For each output management operation to be performed on a document, the output management system may use local and/or remote information about a document's DRM history to determine whether the output management operation is an allowed output management operation for each of the DRM privileges associated with the document. If the output management operation is listed as an allowed output management operation, the output management operation does not violate the DRM privilege. If the output management operation is not listed as an allowed operation, the output management operation violates the DRM privilege. If the output management system does not have information on how to validate a specific output management operation against one or more DRM privileges, the output management operation may be assumed to violate the DRM privilege.

Alternatively, a database or lookup table may store one or more DRM privileges and one or more prohibited output management operations for each DRM privilege. For each output management operation to be performed on a document, the computing device may determine whether the output management operation is listed in the database as a prohibited output management operation for each of the DRM privileges associated with the document. If the output management operation is listed as a prohibited output management operation for a DRM privilege, the output management operation violates the DRM privilege. If the output management operation is not listed as a prohibited output management operation for a DRM privilege, the output management operation does not violate the DRM privilege.

For example, a output management operation to be performed on a document may include printing. Exemplary DRM privileges associated with the document may specify that only User A can print the document, and only three copies of the document can be printed. Table 1 illustrates exemplary database or lookup table entries for these two DRM privileges.

TABLE 1

| | Prohibited Workflow |
|---|---|
| DRM Privilege | Operations |
| Only User A can print | Printing |
| Only three copies of the | Printing |
| document can be printed | |

In an embodiment, an output management system may determine whether the user requesting that the document be printed is User A. If it is, printing does not violate the DRM privilege that only User A can print the document. If the user requesting the document be printed is not User A, printing does violate the DRM privilege.

In an embodiment, an output management system may determine how many copies of the document have already been printed. If the number of documents that have already been printed is less than three, printing does not violate the DRM privilege that only three copies of the document be printed. If the number of documents is equal to or greater than three, then printing violates the DRM privilege that only three copies of the document be printed.

In an embodiment, an output management system may determine a status for one or more of the output management operations. For example, if a requested output management operation violates one or more of the DRM privileges, the output management operation may be assigned a “deny” status. If a requested output management operation does not violate any of the DRM privileges, the output management operation may be assigned an “allow” status. If it is unclear whether an output management operation violates a DRM privilege, the output management operation may be assigned a “deny” status. In an embodiment, a notification may be generated if any of the operations have a “deny” status. For example, an email may be sent to a document's creator notifying the creator of the output management operations that have a “deny” status. Additional and/or alternate statuses may be used within the scope of this disclosure.

In an embodiment, an output management system may automatically cause 215 one or more output management operations to be performed based on each operation's associated status. For example, an output management system may automatically cause 215 one or more output operations associated with an “allow” status to be performed. In an embodiment, the output management system may cause another computing device, a printing device and/or the like to perform one or more output management operations on a document. In an embodiment, the computing device may perform one or more output management operations on a document. For example, an output management system may automatically cause 215 an operation having an “allow” status to be performed. As another example, the computing device may cause 215 one or more output management operations having a “deny” status to not be performed.

In an embodiment, the output management system may only cause 215 output management operations that have a certain status to be performed on a document. For example, the output management system may only cause 215 output management operations that have an “allow” status to be performed. In an embodiment, an output management system may not cause 215 any output management operations to be performed if one or more output management operations have a certain status. For example, an output management system may not cause 215 any output management operations that have a “deny” status to be performed. In an embodiment, an output management system may perform operations until it encounters an operation having a “deny” status. At this time, the output manager may notify the document's creator that an operation has a “deny” status.

In an embodiment, an output management system may allow or deny 220 certain operations or features based on the DRM privileges set forth in the license associated with the document. For example, DRM privileges associated with a DRM document may allow a certain user to print the DRM document, but provides that the contents of the DRM document are not otherwise to be divulged. In response, the output management system may deny an option to see a job preview, an option to print to unsecured print destinations and/or the like. In an embodiment, a computing device may allow or deny 220 options, such as print quantity and/or the like, based on the document's DRM privileges.

In an embodiment, an output management system may route 225 one or more documents to a print device based on the print attributes of the document and/or the rights associated with the document. In an embodiment, an output management system may determine one or more print attributes associated with a document to be printed. The output management system may compare the print attributes of a document to the capabilities of one or more print devices. For example, a document may be printed in color and on 11″×17″ paper. An output management system may communicate with a fleet of three printers. Table 2 illustrates exemplary printers and associated capabilities according to an embodiment.

TABLE 2

| Printer | Capabilities |
|---|---|
| Printer 1 | Black and White |
| | 8½″ × 11″ Paper |
| Printer 2 | Black and White |
| | Color |
| | 8½″ × 11″ Paper |
| Printer 3 | Color |
| | 8½″ × 11″ Paper |
| | 11″ × 17″ Paper |

As illustrated by Table 2, the output management system may route 225 the print job to Printer 3 because Printer 3 is capable of printing in color and on 11″×17″ paper.

In an embodiment, an output management system may determine whether a document is associated with one or more DRM privileges. If it is, the output manager may route the document to a print device that not only has the capabilities necessary to print the document, but also a print-device that is DRM-compliant. In an embodiment, a DRM-compliant print device may be one that is capable of decrypting a DRM document's content and printing the DRM document. In an embodiment, if the document is not associated with one or more DRM privileges, the output manager may route the document to a print device that has the capabilities necessary to print the document, but that is not DRM-compliant.

For example, Table 3 illustrates exemplary print devices, their capabilities and whether or not they are DRM-compliant. If an output management system needs to route a document that is to be printed in black and white and on 8½″ by 11″ paper and that is associated with DRM privileges, the output management system may route the document to Printer 1.

TABLE 3

| Printer | Capabilities | DRM-Compliant |
|---|---|---|
| Printer 1 | Black and White | Yes |
| | 8½″ × 11″ Paper | |
| Printer 2 | Black and White | No |
| | Color | |
| | 8½″ × 11″ Paper | |
| Printer 3 | Color | Yes |
| | 8½″ × 11″ Paper | |
| | 11″ × 17″ Paper | |

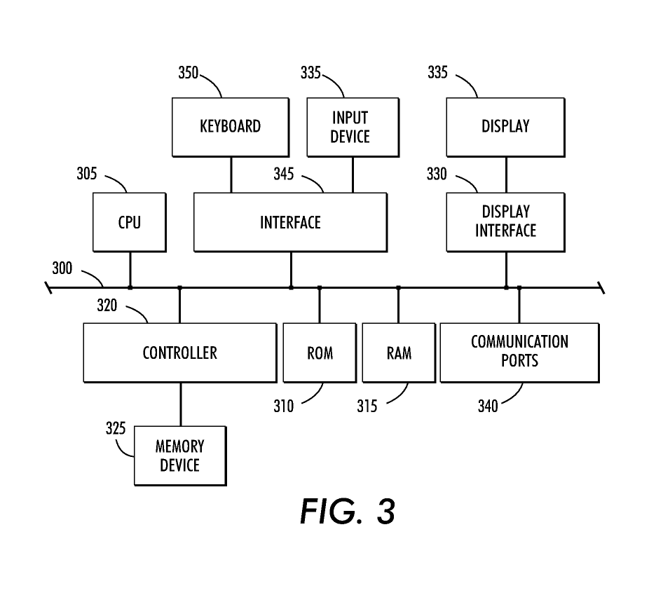

FIG. 3 depicts a block diagram of exemplary internal hardware that may be used to contain or implement program instructions, such as the process steps discussed above in reference to FIG. 2, according to an embodiment. A bus 300 serves as the main information highway interconnecting the other illustrated components of the hardware. CPU 305 is the central processing unit of the system, performing calculations and logic operations required to execute a program. CPU 305, alone or in conjunction with one or more of the other elements disclosed in FIG. 3, is an exemplary processing device, computing device or processor as such terms are used within this disclosure. Read only memory (ROM) 310 and random access memory (RAM) 315 constitute exemplary memory devices.

A controller 320 interfaces with one or more optional memory devices 325 to the system bus 300. These memory devices 325 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 310 and/or the RAM 315. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

An optional display interface 330 may permit information from the bus 300 to be displayed on the display 335 in audio, visual, graphic or alphanumeric format. Communication with external devices, such as a printing device, may occur using various communication ports 340. An exemplary communication port 340 may be attached to a communications network, such as the Internet or an intranet.

The hardware may also include an interface 345 which allows for receipt of data from input devices such as a keyboard 350 or other input device 355 such as a mouse, a joystick, a touch screen, a remote control, a pointing device, a video input device and/or an audio input device.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method of printing a document having digital rights management privileges, the method comprising:
receiving, by an output management system, a print stream comprising a document to be printed and a license associated with the document, wherein the license comprises one or more digital rights management (DRM) privileges;
identifying, by the output management system, one or more output management operations associated with printing the document;
for each output management operation:
determining, by the output management system, whether the output management operation violates any of the DRM privileges associated with the document,
in response to the output management operation violating one or more of the DRM privileges, assigning, by the output management system, a first status to the output management operation, and
in response to the output management operation not violating one or more of the DRM privileges, assigning, by the output management system, a second status to the output management operation;
assigning, by the output management system, the document to a print device that is DRM-compliant and capable of printing the document in accordance with each print attribute associated with the document; and
instructing the print device, by the output management system, to print the document in accordance with each output management operation having the second status.

2. The method of claim 1, wherein determining whether the output management operation violates any of the DRM privileges associated with the document comprises comparing the output management operation to each DRM privilege associated with the document to determine whether the document production operation violates the DRM privilege.

3. The method of claim 1, wherein receiving a print stream comprises receiving a print stream from a workflow system.

4. The method of claim 3, wherein receiving a print stream comprises receiving a print stream from a workflow system via a print queue associated with the output management system.

5. A system of printing a document having digital rights management privileges, the system comprising:
a computing device; and
a computer-readable storage medium in communication with the computing device, wherein the computer-readable storage medium comprises one or more programming instructions that, when executed, cause the computing device to:
receive a print stream comprising a document to be printed and a license associated with the document, wherein the license comprises one or more digital rights management (DRM) privileges,
identify one or more output management operations associated with printing the document,
for each output management operation:
determine whether the output management operation violates any of the DRM privileges associated with the document,
in response to the output management operation violating one or more of the DRM privileges, assign a first status to the output management operation, and
in response to the output management operation not violating one or more of the DRM privileges, assign a second status to the output management operation,
assign the document to a print device that is DRM-compliant and capable of printing the document in accordance with each print attribute associated with the document, and
instruct the print device to print the document in accordance with each output management operation having the second status.

6. The system of claim 5, wherein the one or more programming instructions that cause the computing device to determine whether the output management operation violates any of the DRM privileges associated with the document comprises one or more programming instructions that, when executed, cause the computing device to compare the output management operation to each DRM privilege associated with the document to determine whether the document production operation violates the DRM privilege.

7. The system of claim 5, wherein the one or more programming instructions that cause the computing device to receive a print stream comprise one or more programming instructions that, when executed, cause the computing device to receive a print stream from a workflow system.

8. The system of claim 7, wherein the one or more programming instructions that cause the computing device to receive a print stream comprise one or more programming instructions that, when executed, cause the computing device to receive a print stream from a workflow system via a print queue associated with the computing device.

9. A system of printing a document having digital rights management privileges, the system comprising:
a workflow system;
an output management system in communication with the workflow system, wherein the output management system is configured to receive a print stream from the workflow system via a print queue, wherein the print stream comprises a document and a license associated with the document, wherein the license comprises one or more digital rights management (DRM) privileges;
one or more print devices in communication with the output management system,
wherein the output management system is configured to route the print stream to one of the one or more print devices based on one or more of the DRM privileges and one or more print attributes associated with the document.

10. The system of claim 9, wherein the output management system is configured to:
identify one or more print attributes associated with the document;
identify a print device from the one or more print devices that is capable of printing the document in accordance with each associated print attribute; and
assign the document to the identified print device to be printed.

11. The system of claim 9, wherein the output management system is configured to:
identify one or more print attributes associated with the document;
identify at least one print device from the one or more print devices that is capable of printing the document in accordance with each associated print attribute; and
assign the document to an identified print device that is DRM-compliant.
